(19) United States
(12) Patent Application Publication
(10) Pub. No.: US 2026/0131501 A1
(43) Pub. Date: May 14, 2026

(54) NOZZLE FOR 3D PRINTING CONSTRUCTION SYSTEM

(71) Applicant: SQ4D PATENT LLC, Patchogue, NY (US)

(72) Inventors: Kristen Elizabeth Henry, Patchogue, NY (US); Edward Bruning, Northport, NY (US); Christopher Michael Jelley, Babylon, NY (US); Sal Ferrari, Shirley, NY (US)

(21) Appl. No.: 19/276,540

(22) Filed: Jul. 22, 2025

Related U.S. Application Data
(60) Provisional application No. 63/674,072, filed on Jul. 22, 2024.

(51) Int. Cl. B28B 1/00; B33Y 30/00

(52) U.S. Cl. CPC B28B 1/001; B33Y 30/00

(57) ABSTRACT

A nozzle for a 3D printing construction system is disclosed. The nozzle has a channel with an inlet and an outlet, the outlet being angled with respect to a deposition surface of a print material. An extrusion system for a 3D printing construction system is also disclosed. The extrusion system includes a tangentially rotating nozzle having a channel with an inlet and a non-circular outlet, the non-circular outlet being angled with respect to a deposition surface of a print material. Methods of constructing a structure with a 3D printing construction system are also disclosed.

### CROSS-REFERENCE TO RELATED APPLICATIONS

This application claims priority under 35 U.S.C. § 119 (e) to U.S. Provisional Patent Application Ser. No. 63/674,072, titled “NOZZLE FOR 3D PRINTING CONSTRUCTION SYSTEM,” filed Jul. 22, 2024, the entire contents of which is incorporated herein by reference for all purposes.

### FIELD OF TECHNOLOGY

Aspects and embodiments disclosed herein relate to 3D printing construction systems. More particularly, aspects and embodiments disclosed herein relate to nozzles for 3D printing construction systems.

### SUMMARY

Examples of the methods and systems discussed herein are not limited in application to the details of construction and the arrangement of components set forth in the following description or illustrated in the accompanying drawings. The methods and systems may be capable of implementation in other embodiments and of being practiced or of being carried out in various ways. Examples of specific implementations are provided herein for illustrative purposes and are not intended to be limiting. Acts, components, elements, and features discussed in connection with any one or more examples may be configured to operate and/or be implemented in a similar role in any other examples.

The phraseology and terminology used herein is for the purpose of description. References to examples, embodiments, components, elements, or acts of the systems and methods herein referred to in the singular may also embrace embodiments including a plurality. Similarly, references in plural to embodiments, components, elements, or acts may be implemented as a singularity. References in the singular or plural form may therefore not be intended to limit the presently disclosed systems or methods, their components, acts, or elements. The use herein of “including,” “comprising,” “having,” “containing,” “involving,” and variations so forth, may encompass the items listed thereafter and equivalents thereof as well as additional items.

References to “or” may be construed as inclusive so that any terms described using “or” may indicate any of a single, more than one, and all of the described terms. For example, the phrase “at least one of A or B” may refer to A and/or B-that is, A only, B only, or A and B together. In addition, in the event of inconsistent usages of terms between this document and documents incorporated herein by reference, the term usage in the incorporated documents is supplementary to this document. For irreconcilable differences, the term usage in this document controls.

In accordance with an aspect, there is provided an extrusion nozzle for a three-dimensional construction system. The system may include a gantry operative along a print path positioned adjacent to a deposition surface. The system may include a nozzle configured to direct a volume of construction material onto the deposition surface. An outlet of the nozzle may be directed at an offset from the print path and the deposition surface to deposit a volume of a construction material at an incident angle on the deposition surface.

In some embodiments, the outlet may have a non-circular cross-sectional profile. The cross-sectional profile of the outlet further may include filleted corners.

In some embodiments, the outlet may have a lateral dimension that is less than a corresponding lateral dimension of the channel. For example, the lateral dimension of the outlet may be between 25% and 99% of the corresponding lateral dimension of the channel. In further embodiments, the nozzle further may include a nozzle tip extension about the nozzle outlet. A longitudinal dimension of the nozzle tip may be between 50% and 100% of the lateral dimension of the outlet.

In further embodiments, the nozzle may include a plurality of serrations distributed about a perimeter of the outlet. The plurality of serrations may be constructed and arranged to indent the volume of construction material as the volume of construction material is deposited. In particular embodiments, any of the plurality of serrations may traverse between 5% and 25% of the outlet.

In some embodiments, a channel of the nozzle further may include a planar surface formed adjacent to the outlet. The planar surface may be proximal to the deposition surface.

In further embodiments, the nozzle may include a fastening structure adjacent to the inlet. The fastening structure may include a threaded feature. In specific embodiments, the fastening structure may include a first flanged connection that mates with a corresponding second flanged connection of the gantry.

In some embodiments, the outlet of the nozzle may be coincident with a central axis of the nozzle.

In accordance with an aspect, there is provided an extrusion control system for a 3D printing construction system. The system may include a gantry operative along a print path. The system may include a tangentially rotating nozzle. The tangentially rotating nozzle may have a channel with an inlet and an outlet with the outlet being configured to extend between a central axis of tangential rotation and a deposition surface.

In some embodiments, the incident angle may be between about 30° to about 60° to the print surface.

In some embodiments, an angular orientation of the tangentially rotating nozzle may be tangent to the print path.

In some embodiments, the nozzle may be configured to deposit a volume of construction material onto the deposition surface at an incident angle. The incident angle may be defined between a centerline of the outlet and the angular orientation of the tangentially rotating nozzle such that the volume of construction material is compressed onto the selected deposition surface.

In accordance with one aspect, there is provided a nozzle for a 3D printing construction system. The nozzle may have a channel with an inlet and an outlet, the outlet being angled with respect to a deposition surface of a print material.

In some embodiments, the outlet has a non-circular cross-sectional area.

In some embodiments, the outlet has a representative dimension that is smaller than a representative dimension of the channel.

In some embodiments, the nozzle further comprises serrations positioned at a top surface of the outlet.

In some embodiments, the cross-sectional area of the outlet comprises filleted corners.

In some embodiments, an internal wall of the outlet comprises an internal straight positioned on a bottom surface of the outlet.

In some embodiments, the nozzle comprises a fastening structure at the inlet.

In accordance with another aspect, there is provided an extrusion system for a 3D printing construction system. The extrusion system may comprise a tangentially rotating nozzle having a channel with an inlet and a non-circular outlet, the non-circular outlet being angled with respect to a deposition surface of a print material.

In some embodiments, the tangentially rotating nozzle is removable.

In some embodiments, the channel is structured to maintain a center of rotation along a central axis of the nozzle.

In accordance with another aspect, there is provided a method of constructing a structure with a 3D printing construction system comprising an extrusion system having a tangentially rotating nozzle having a channel with an inlet and a non-circular outlet, the non-circular outlet being angled with respect to a deposition surface of a print material.

The disclosure contemplates all combinations of any one or more of the foregoing aspects and/or embodiments, as well as combinations with any one or more of the embodiments set forth in the detailed description and any examples.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIGS. 1A-1C include an isometric view, front view, and side view of a partial 3D printing construction system, according to one embodiment;

FIG. 2 is a front view of a modular attachment X-carriage, according to one embodiment;

FIG. 3 is an isometric view of an extruder system, according to one embodiment;

FIG. 4 is an isometric view of an angled non-circular nozzle having a flanged fastening structure between the nozzle and the extruder system, according to one embodiment;

FIGS. 5A-5D include an isometric top view, a sectional side view, a front view, and a side view of an angled non-circular nozzle, according to one embodiment;

FIGS. 6A-6D include an isometric front view, a sectional side view, an isometric back view, and a front view of an angled non-circular nozzle, according to one embodiment;

FIGS. 7A-7B include side views of two angled non-circular nozzles, according to two embodiments;

FIGS. 8A-8C include bottom views of a partial angled non-circular nozzle and an angled non-circular nozzle, according to one embodiment;

FIGS. 9A-9C include a side view, a front view, and a sectional side view of an angled non-circular nozzle, according to one embodiment;

FIGS. 10A-10B include a sectional side view and a partial isometric bottom view of an angled non-circular nozzle, according to one embodiment; and

FIGS. 11A-11D are photographs showing a portion of a structure constructed with a 3D printing construction system, according to certain embodiments.

### DETAILED DESCRIPTION

The disclosure relates to an autonomous robotic construction system that can be used to manufacture or print buildings or building components, such as dwellings, industrial or commercial spaces, and other structures. The system includes a frame, an extrusion system, and a nozzle. Traditional construction procedures involve framing a wall with extensive labor involved. Much of the work is manual and subject to human error. The systems disclosed herein may provide improved automated construction of buildings by a 3D print construction process.

Conventional robotic construction systems commonly print with such printing materials as concrete, clay, plastic, and/or polymers and typically print with the nozzle positioned orthogonal to the surface upon which the extrusion is occurring. However, downward extrusion with such a configuration often produces material beads that are not uniform in shape and/or size. It is believed that downward pressure caused by the downward extrusion or deposition of printing material causes a trapezoidal effect on the bead, making the bottom of the deposited layer wider than the top. This trapezoidal profile also makes stacking taller beads more difficult. While it may be possible to increase the corresponding width of the bead, such an increase would diminish the usable area within the structure. Thus, there exists a need for an improved nozzle that reduces or limits the trapezoidal effect caused by downward pressure upon deposition of the print material.

A system for constructing 3D printed structures using an angled, non-circular, tangentially rotating nozzle is disclosed herein. The nozzle may deposit and press the material, resulting in a more uniform bead, while still allowing for proper adhesion between layers of printed material. Thus, the disclosure provides a system for 3D printing cementitious materials, with a significant improvement in the uniformity of the deposited bead, as compared to systems that utilize conventional nozzles, for example, nozzles that deposit material perpendicularly to the build surface.

The nozzles described herein may also allow for deposition of taller beads, given the same specified width and slump of the material. Printing taller beads may be enabled by pressure build up within the nozzle, which allows for shaping and deposition of the material without over-pressing the bead downward.

Utilizing a nozzle with a non-circular opening may reduce the trapezoidal effect and improve stacking of consecutive layers. 3D printing with a non-circular nozzle may require rotation of the nozzle to produce a bend or curvature in the structure. Arms or trowels, which are sometimes used for shaping the bead, may not allow tight rotation, as any part of the nozzle that falls below the top plane of the bead is subject to collision with previously printed material. When rotating a nozzle while printing, it may be beneficial to maintain the center of extrusion along the central axis of rotation in order to prevent corners from swinging out while turning.

Examples of various 3D printing nozzles are well established in patent literature. One exemplary non-circular nozzle is described in U.S. Patent Application Publication No. 2019/0316344 titled “Autonomous robotic construction system and method,” (attached hereto as an Appendix) which is herein incorporated by reference in its entirety for all purposes.

In accordance with one aspect, there is provided a nozzle for 3D printing a structure, such as a dwelling or other constructed structure. The nozzle may be fitted onto an autonomous 3D printing construction system. Thus, the nozzle may be dimensioned to correspond with an outlet of a 3D printing construction system, for example, dimensioned to mate with an outlet of a 3D printing construction system. In some embodiments, the nozzle may be removable, for example, containing an attachment mechanism, such as a thread and/or fasteners or another coupling structure, to easily reversibly attach the nozzle to the outlet of the 3D printing construction system.

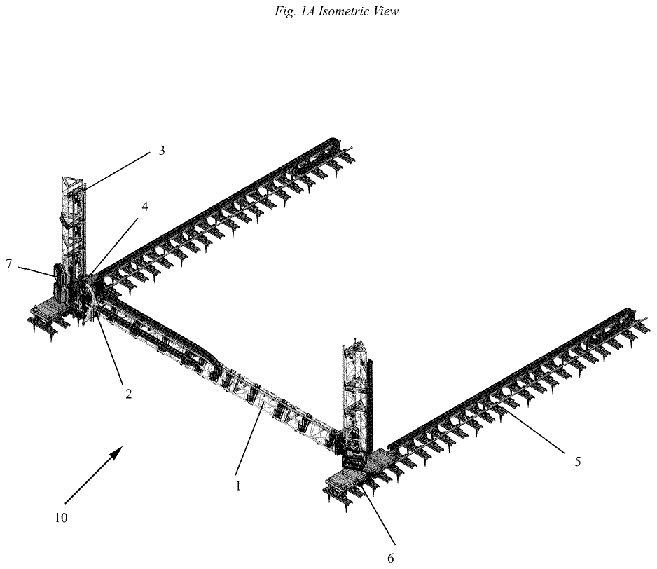

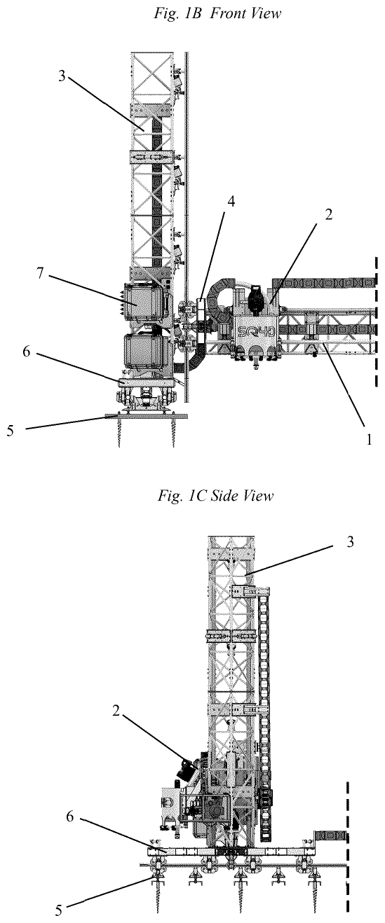

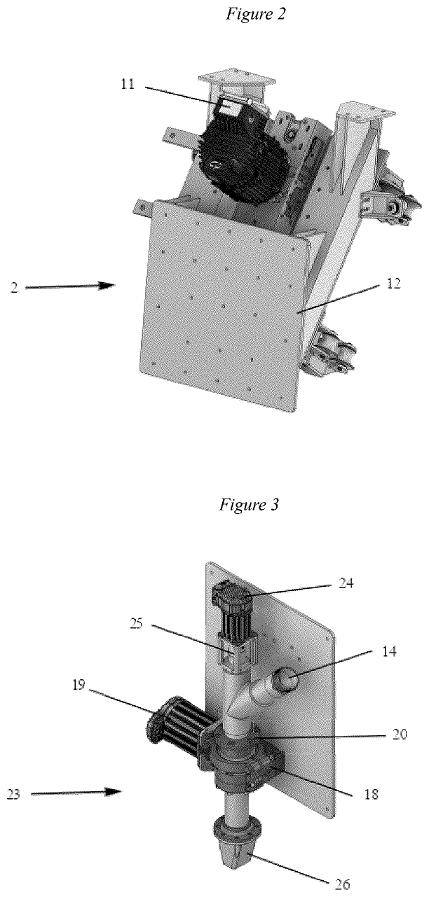

As seen in FIG. 1A-1C, the construction system 10 includes an x-axis gantry 1, y-axis tracks 5, and z-axis towers 3 to allow for multi directional movement and the creation of layered 3-dimensional structures. X-axis carriage 2 allows for horizontal movement by motor 11 (FIG. 2). Z-axis carriage 4 travels up and down the z-towers 3 in order to move the gantry up and down in the vertical direction. Y-axis carriage 6 travels back and forth on y-axis tracks 5 in order to move the gantry and towers along the length of the print. Control and network box 7 contains the CPU and electronic components used to control the movement of the printer and the functions of the various technological systems and components in the exemplary construction system 10. As seen in FIG. 2, the x-axis gantry may include a base plate 12 that accommodates multiple different printing and utility functions. An example of an extruder system is extruder system 23, shown in FIG. 3, that can be attached to base plate 12 of x-carriage 2. The extruder system 23 includes an auger 25 rotated by auger motor 24. Material enters the extruder 23 via inlet 14. Extruder 23 features joints to allow for tangential rotation of the nozzle according to a print path, such that the nozzle is constantly oriented along the curvature of a programmed print.

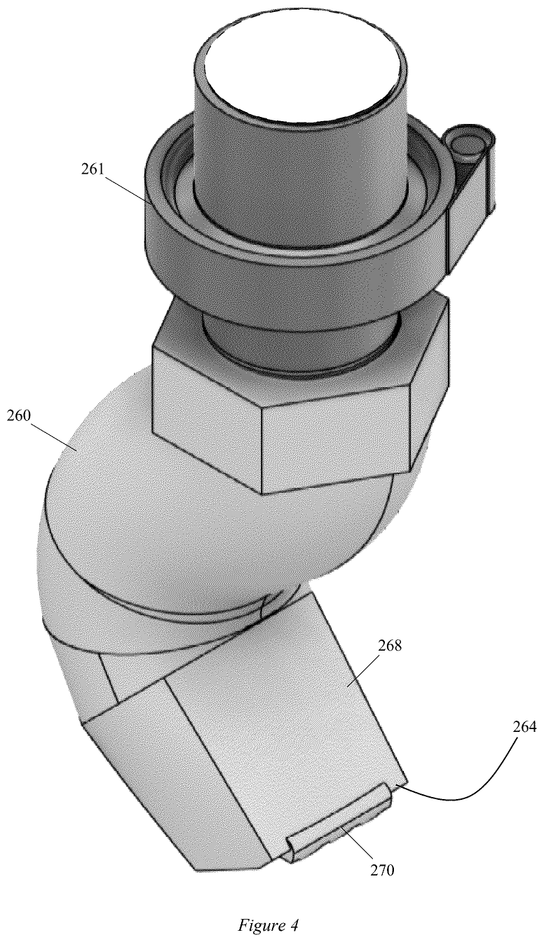

The print path is broadly contemplated to encompass all machine-motion executable by the gantry and extruder system, inclusive of motion along X, Y and Z axes and also a rotational A-axis (yaw) defined about a plane orthogonal to the nozzle. In operation, the orientation about the A-axis is derived from the print path set along the X-Y plane such that the orientation of the nozzle is always tangent to the print path at each minute of arc through any turns defined within said print path. This enables directional printing to allow for clean turns and curves with a non-circular nozzle 26 as illustrated in FIG. 4, wherein the gantry is operative along the print path at incremental Z-heights in successive layers to create a stable standing structure. The extruder system 23 may be fitted with differing nozzle heads to perform different functions, as described in more detail below. Tangential rotation is possible due to gear assembly 18, tangential motor 19, and rotary joint 20.

As illustrated in FIG. 4, an embodiment of the coupling structure is a flanged connection using an external fastener or coupling. As illustrated, the flanged coupling is formed by aligning a matched diameter set of tapered couplings with a gasket or other appropriate sealant deposited within the coupling surface, though not obstructing the inner diameter of the conduit. A band clamp 261 is affixed to the external tapered surface of the couplings and tightened, forcing the couplings together as the inner diameter of the clamp cams against the tapered surfaces.

This type of connection is contemplated as one mechanism for exchanging the nozzle during normal use of the 3D printing construction system. Exchanging the nozzle is a time-sensitive operation as the construction material in the printer hose is generally not purged prior to exchanging the nozzle, so any delay during the exchange increases the likelihood of the construction material settling or curing inside the printer hose. Additionally, in the event of a material clog at the nozzle, the nozzle is able to detach to allow an operator ready access into the printer head assembly to clear any blockage with a minimal delay.

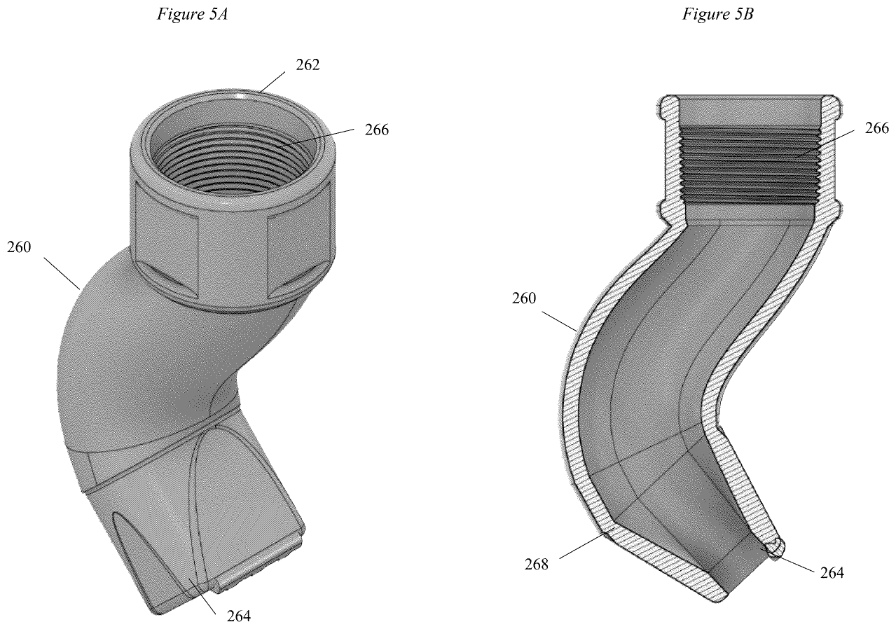

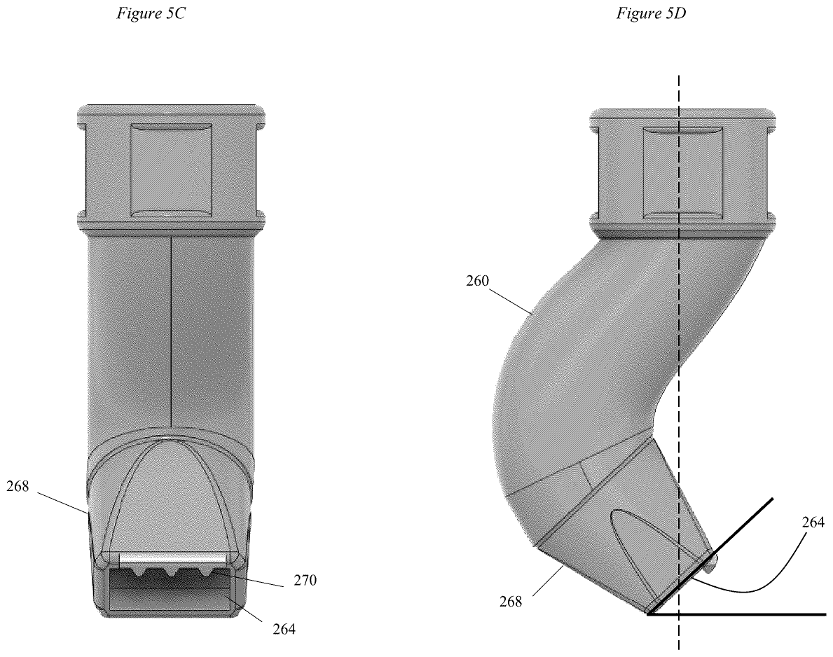

Different nozzle designs may allow for variations in deposition of the material. Various embodiments of nozzles are shown in FIGS. 5A-10B and described in more detail below.

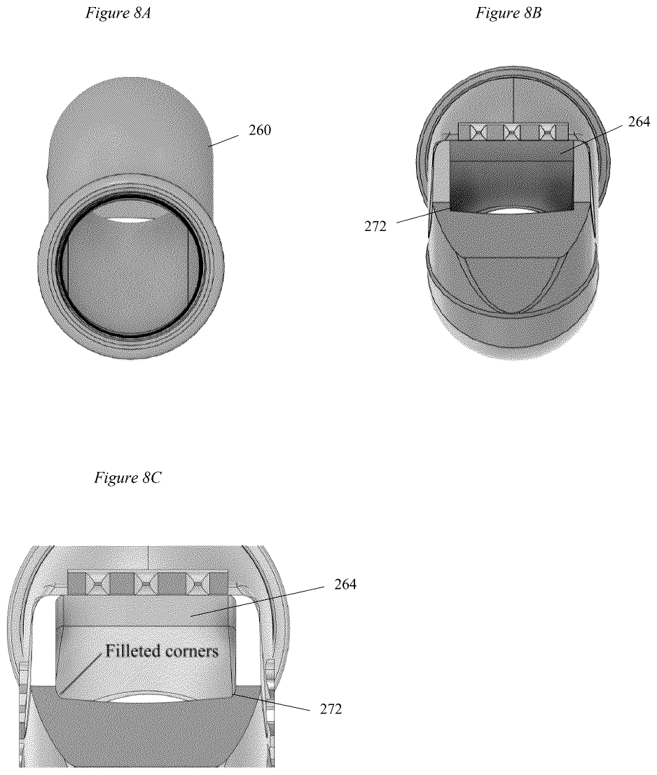

As shown in FIGS. 5A-5D, the nozzle may have a channel 260, for example, a tubular channel, and include an inlet 262 and an outlet 264. In some embodiments, the channel 260 may have a circular cross-section, as shown in the bottom view of FIG. 8A. In other embodiments, the channel 260 may have a non-circular cross-section. The nozzle may comprise a fastening structure adjacent or proximate the inlet, for fastening to the extruder. The exemplary nozzle of FIGS. 5A-5D includes threads 266.

The outlet 264 may be angled, as shown in FIG. 5D. The nozzle may be designed, for example, structured, to allow the material to be deposited at an angle relative to the surface of deposition. In some embodiments, the nozzle outlet is angled about 30°-60° with respect to the deposition surface of the print material. For example, the nozzle outlet may be angled about 30°, about 40°, about 45°, about 50°, or about 60° with respect to the deposition surface of the print material.

Depositing certain materials, such as cementitious materials, at an angle relative to the deposition surface may reduce or limit the trapezoidal effect typically produced by perpendicular deposition of such materials. Thus, in some embodiments, the angle may be effective to reduce or limit the trapezoidal effect of deposition. More specifically, the construction material extruded at a low incident angle to the print surface is observed to over-compress or slump, deviating the finished bead profile from the profile of the outlet. Conversely, axial extrusion, i.e., a high incident angle, is observed to maintain profile fidelity to a greater extent, though some adhesion-quality is sacrificed as the construction material is not forcefully embedded onto the print surface. This may result in “dry-stacking”, a situation where the construction material fails to adhere to the print surface and thus produces a structure that is vulnerable to shear-loading. Accordingly, an incident angle between about 30° to about 60° provides for axial extrusion to maintain profile fidelity with sufficient downward pressure to ensure an effective bond between layers.

Furthermore, it may be beneficial to maintain a center of gravity of the nozzle during rotation, for example, while printing corners and curves. Thus, in some embodiments, the channel 260 may be designed, for example, structured, to maintain a center of rotation along a central axis of the nozzle. The channel 260 may be offset from a center plane of the nozzle to form the desired angle at the outlet 264, as shown in FIG. 5D, while maintaining the center of rotation. The offset may be in the form of a curve having a radius effective to form the desired angle at the outlet 264.

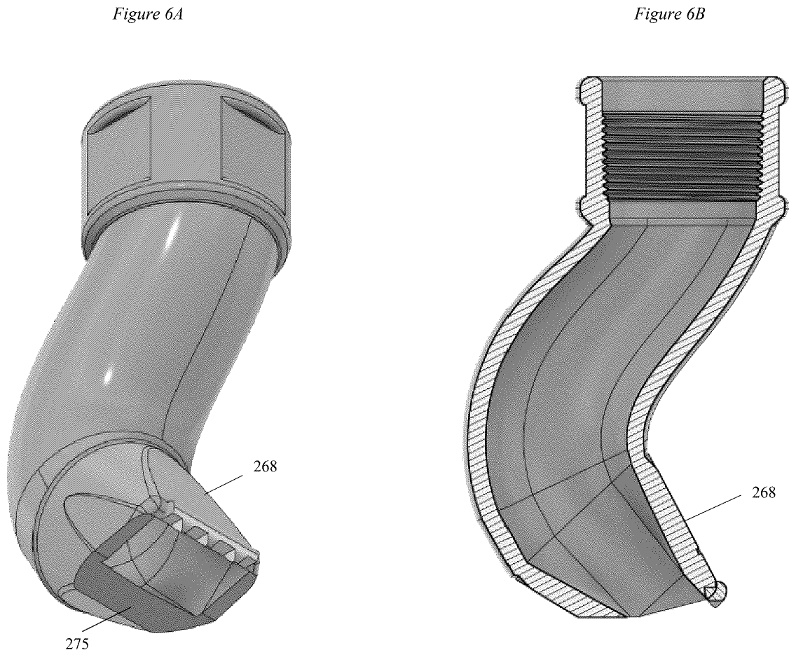

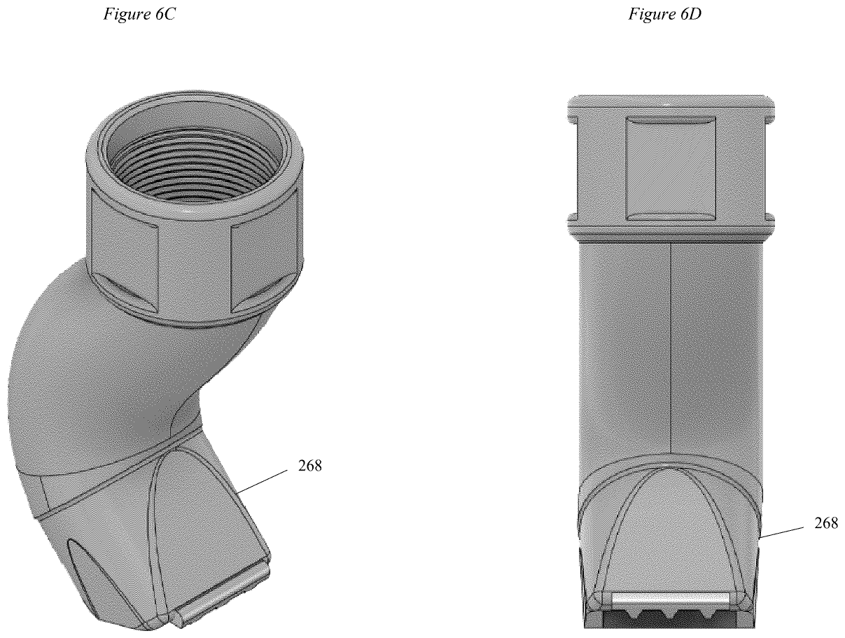

It is further contemplated that any offsets or convolutions of the channel may be used to affect a reduction in material flow rate. Convolutions are herein understood to indicate deviations from a normal, linear path from the inlet 262 to the outlet 264, as illustrated with the serpentine embodiments in FIG. 5B through 6B. It is specifically contemplated that introducing a barrier, i.e., the inner sidewall of the channel 260, into the path of material flow increases friction between the construction material and the channel 260, thereby creating a reduction in overall material flow between the inlet 262 and the outlet 264. The degree of deviation introduced to the channel 260, defined by the number and severity of convolutions, may be used to constantly restrict flow through the channel 260 to mitigate any variance in pumping action or material viscosity. Further, in embodiments wherein the construction material is a suspension, e.g., a cementitious slurry with entrained aggregate, the increased friction between the convolutions of the channel 260 and the construction material may affect a desirable mixing effect immediately prior to extrusion through the outlet 264.

It may also be beneficial to maintain sufficient downward pressure to adhere adjacent layers of the material. The nozzle may be designed to deposit the material at an angle, while maintaining sufficient downward pressure. For example, a length of the nozzle tip 268 may be selected to provide a desired downward pressure while depositing the material at an angle incident to the print surface. This angle is broadly contemplated to be effective between about 1 and about 89 degrees from vertical, dependent on the required force to ensure an effective bond between the extruded construction material and the print surface. As noted herein, an incident angle between 30 and 60 degrees provides a balance between profile fidelity and layer adhesion. As shown in FIG. 5B, the outlet 264 may be dimensioned smaller than a representative dimension of the channel 260. In some embodiments, the nozzle tip 268 may be tapered to form an outlet 264 having a smaller dimension than the channel 260. Thus, the nozzle tip 268 may be designed to build pressure at the outlet 264. The nozzle may be designed to deposit the material with the desired downward pressure by directing the pressurized flow of the construction material downwards towards the print surface. This axial extrusion will produce a deformed extrudate, as the pressurized flow of construction material is compressed into the print surface under the momentum of the material itself, and by the force of additional material being expelled from the nozzle tip 268 at force.

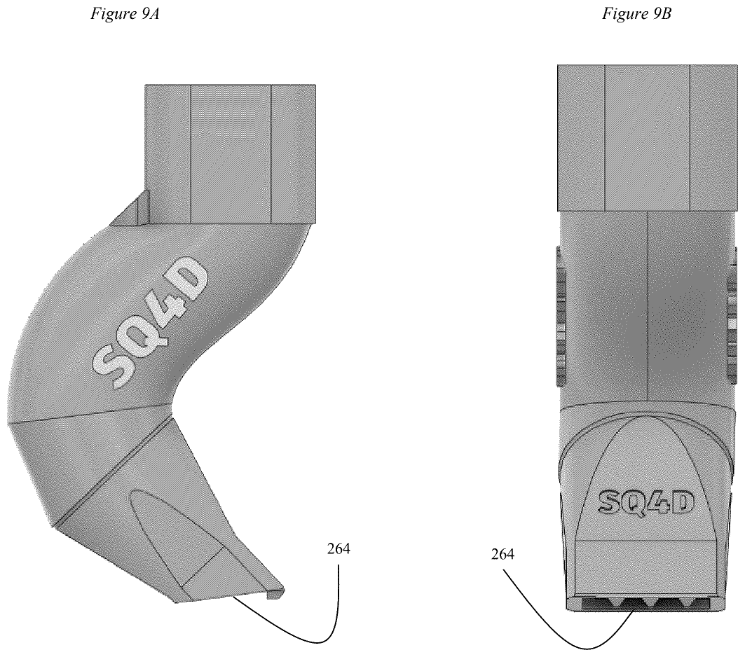

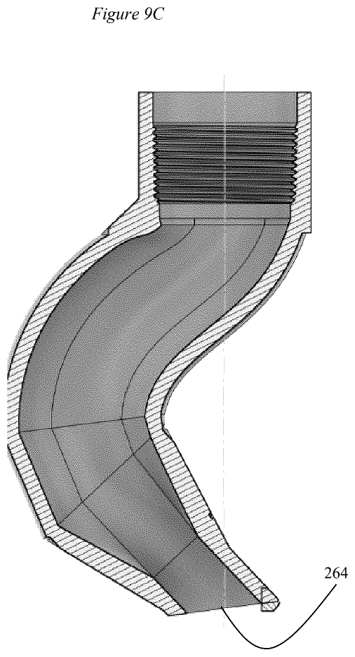

In some embodiments, as shown in FIGS. 9A-9C, the outlet 264 may have an even smaller cross-sectional area or representative dimension. The smaller outlet 264 may allow the deposited material to be even more uniform upon extrusion, reducing or eliminating the need for forming or scraping the material after extrusion. For example, a smaller rectangular outlet, as shown in the exemplary embodiment of FIGS. 9A-9C may form a more uniformly rectangular bead upon extrusion.

In some embodiments, the cross-sectional area of the outlet 264 may be dimensioned to provide a desired downward pressure while depositing the material at an angle. As shown in the exemplary embodiment of FIGS. 6A-6D, the nozzle tip 268 may be shortened. A shortened nozzle tip 268 may increase downward pressure, which may allow the deposited bead to better adhere to adjacent layers and maintain a desired cross-sectional profile. Furthermore, a shortened nozzle tip 268 may reduce or prevent the likelihood of the nozzle colliding with previously printed material below the top plane of the adjacent layer.

In some embodiments, the channel 260 may have a representative dimension defining a measurement of the geometry of the nozzle outlet, thereby defining a dimension of the extrudate construction material. In the exemplary embodiments of FIGS. 5A-5D, the representative dimension of the channel 260 is a diameter. However, the representative dimension of the channel 260 may be a length, width, or diagonal.

In some embodiments, the nozzle outlet 264 may have a representative dimension of between about 0.5-1.5 inches, for example, between about 0.5-0.75, 0.75-1.0, 1.0-1.25, or 1.25-1.5 inches. In the embodiments illustrated in FIGS. 5A-5D, the representative dimension of the nozzle outlet 264 is a length. However, the representative dimension of the nozzle outlet 264 may be a diameter, width, or diagonal. Furthermore, in the exemplary embodiments shown in FIGS. 5A-5D, the width of the nozzle outlet 264 is substantially equivalent to the diameter of the channel 260.

In some embodiments, the representative dimension of the nozzle outlet 264 is between 25-100% of the representative dimension of the channel 260, for example, the representative dimension of the nozzle outlet 264 may be between 25-50%, 50-75%, or 75-100% of the representative dimension of the channel 260.

In some embodiments, the nozzle tip 268 has a length between about 50-100% of the representative dimension of the nozzle outlet 264. For example, a longer nozzle tip 268 may have a length between 75-100%, for example, between 75-85% or 85-100% of the representative dimension of the nozzle outlet 264. A shorter nozzle tip 268 may have a length between about 50-75%, for example, 50-65% or 65-75% of the representative dimension of the nozzle outlet 264. The length of the nozzle tip 268 may be measured from the point in which the channel 260 begins to taper until the nozzle outlet 264.

As shown in FIG. 5C, the outlet 264 may be non-circular. The exemplary non-circular outlet 264 shown in FIG. 5C is rectangular. However, the non-circular outlet 264 may be triangular, rectangular, square, trapezoidal, polygonal, e.g., pentagonal, hexagonal, heptagonal, or octagonal, or irregularly shaped. A non-circular outlet having a rectangular cross-section may have a length selected to provide a desired material bead height when deposited. Thus, the nozzle outlet 264 of FIG. 5D has a length selected to provide the desired material bead height. The cross-sectional area of the channel 260 may be selected to provide continuity to the geometry of the extruder hose and adapt the geometry of the extruder outlet to the geometry of the nozzle outlet 264. The cross-sectional area of the channel 260 of the exemplary embodiments of FIGS. 5A-5D is circular, which is designed to be used with an extruder hose having a circular outlet. In this configuration, the nozzle is constructed and arranged to adapt a circular bead from the extruder through the channel 260 into a non-circular bead at the nozzle outlet 264. In other embodiments, the cross-sectional area of the channel 260 may be non-circular.

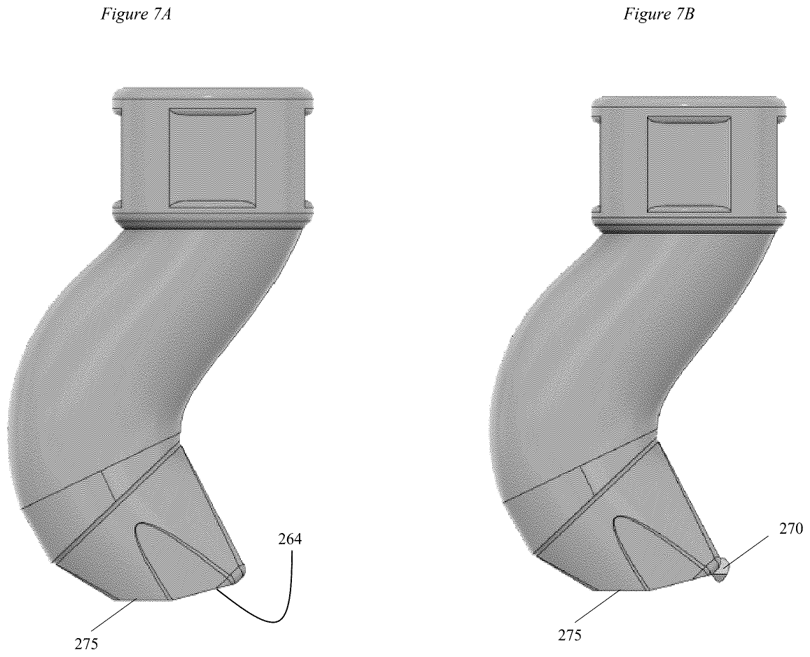

As also shown in FIG. 5C, in certain embodiments, the nozzle may include a plurality of serrations 270. The serrations 270 may include one or more teeth projecting from an internal wall of the nozzle tip 268. The serrations 270 may produce indentations on the printed material as it exits the nozzle. These indentations are a series of continuous grooves for keying the printed layers together. The grooves allow adjacent layers to interlock both mechanically and chemically by increasing the available surface area of the upper facet of a printed bead, thus allowing for a water-tight seam to be formed as a subsequent printed layer is extruded onto this grooved surface. It is further contemplated that alternate indentations may be formed by varying the shape and dimensions of any of the plurality of serrations, inclusive of embodiments of the present invention that feature removable or interchangeable components bearing said plurality of serrations. FIG. 7A is a side view of a nozzle that does not include an outlet structure, such as serrations 270. FIG. 7B is a side view of a nozzle that includes serrations 270. As illustrated in FIGS. 6A, 7A, and 7B, the nozzle includes a planar surface 275 distributed from the outlet along the exterior of the nozzle body, generally oriented parallel to the print surface, such that the nozzle may be navigated close to the print surface without risking collision with a previously printed layer.

The serrations 270 may include 1-10 teeth or more, for example, the serrations may include 1, 2, 3, 4, 5, 6, 7, 8, 9, 10, 2-4, 3-5, or 5-10 teeth. Each tooth may have a length of between about 0.05-0.2 inches, for example, between 0.05-0.1, 0.1-0.15, or 0.15-0.2 inches. Each tooth may have a length between 5-25% of the length of the nozzle opening, for example, between 5-10%, 10-15%, 15-20%, or 20-25% of the length of the nozzle opening. The length of the serrations 270 may be selected depending on the desired size of the grooves. In some embodiments, each tooth may have a similar length. In some embodiments, each tooth need not have a similar length.

In some embodiments, as shown in FIGS. 8B-8C, the outlet 264 may have fillets 272, for example, filleted corners. The fillets 272 may produce an extruded bead having very slightly rounded, i.e., chamfered, edges, which may allow adjacent layers to stack with a less noticeable differentiation between layers.

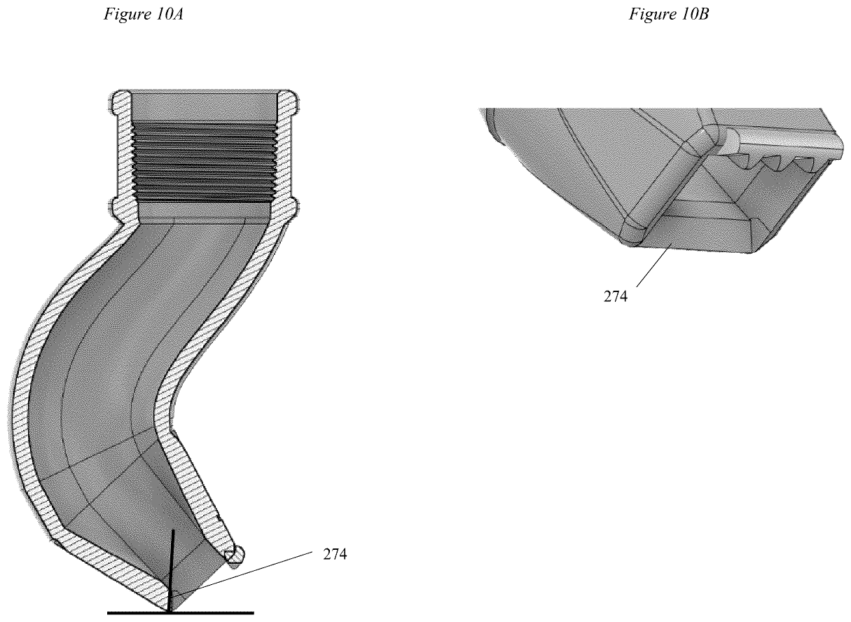

In some embodiments, as shown in FIGS. 10A-10B, the nozzle may comprise an internal straight 274 at the outlet 264. The internal straight 274 may be formed by tapering the wall of the nozzle tip 268 to be substantially vertical at the bottom of the outlet 264 (FIG. 10A). The internal straight 274 may further increase downward pressure of the deposited material. The length of the internal straight 274 effective to produce a substantially vertical surface will generally depend on the angle of the outlet 264.

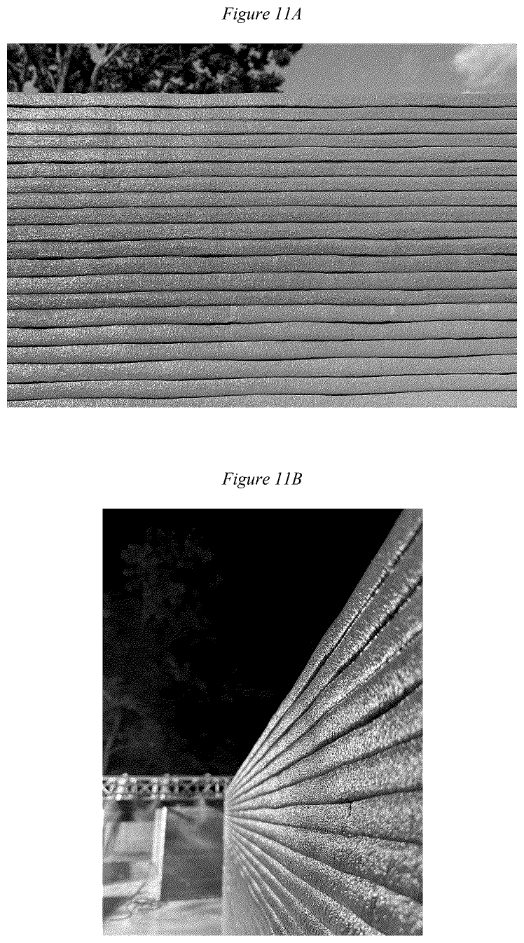

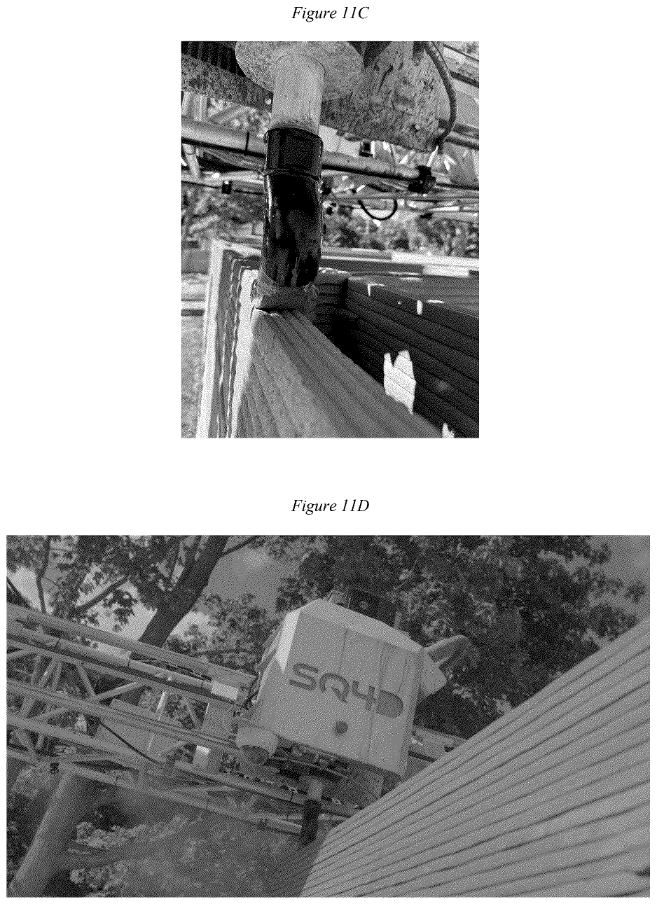

The angled, non-circular, tangentially rotating nozzle as described herein was shown to produce a more uniform deposited bead of cementitious material, while still allowing for proper adhesion between adjacent layers of the material. FIGS. 11A-11D are photographs showing portions of a structure constructed with an angled, non-circular, tangentially rotating nozzle.

FIG. 11A is a photograph showing a front view of a portion of a wall constructed with the angled, non-circular, tangentially rotating nozzle. FIG. 11B is a photograph showing a side perspective view of a portion of a wall constructed with the angled, non-circular, tangentially rotating nozzle. A plurality of stacked layers forming the wall are visible in the photographs of FIGS. 11A-11B. The x-axis gantry is visible in the background of the photograph of FIG. 10B. FIG. 11C is a photograph showing an angled, non-circular, tangentially rotating nozzle printing a bead of material over an adjacent material layer. Three grooves produced by serrations at the nozzle outlet are visible atop the adjacent material layer. FIG. 11D is a photograph showing the x-axis carriage with an angled, non-circular, tangentially rotating nozzle printing a bead of material over an adjacent material layer. The angled, non-circular, tangentially rotating nozzle is positioned at the outlet of the extruder.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

What is claimed is:

1. An extrusion nozzle for a three-dimensional construction system comprising:
a gantry operative along a print path positioned adjacent to a deposition surface; and
a nozzle configured to direct a volume of construction material onto the deposition surface, an outlet of the nozzle directed at an offset from the print path and the deposition surface to deposit a volume of a construction material at an incident angle on the deposition surface.

2. The nozzle of claim 1, wherein the outlet comprises a non-circular cross-sectional profile.

3. The nozzle of claim 1, wherein the outlet comprises a lateral dimension that is less than a corresponding lateral dimension of the channel.

4. The nozzle of claim 1, further comprising a plurality of serrations distributed about a perimeter of the outlet, the plurality of serrations constructed and arranged to indent the volume of construction material as the volume of construction material is deposited.

5. The nozzle of claim 2, wherein the cross-sectional profile of the outlet further comprises filleted corners.

6. The nozzle of claim 1, wherein the channel further comprises a planar surface formed adjacent to the outlet, the planar surface proximal to the deposition surface.

7. The nozzle of claim 1 further comprising a fastening structure adjacent to the inlet.

8. The nozzle of claim 7, wherein the fastening structure comprises a threaded feature.

9. The nozzle of claim 7, wherein the fastening structure comprises a first flanged connection that mates with a corresponding second flanged connection of the gantry.

10. The nozzle of claim 1, wherein the outlet of the nozzle is coincident with a central axis of the nozzle.

11. An extrusion control system for a 3D printing construction system, comprising:
a gantry operative along a print path; and
a tangentially rotating nozzle, the tangentially rotating nozzle having a channel with an inlet and an outlet with the outlet being configured to extend between a central axis of tangential rotation and a deposition surface.

12. The extrusion system of claim 11, wherein an angular orientation of the tangentially rotating nozzle is tangent to the print path.

13. The extrusion system of claim 12, wherein the nozzle is configured to deposit a volume of construction material onto the deposition surface at an incident angle, the incident angle defined between a centerline of the outlet and the angular orientation of the tangentially rotating nozzle such that the volume of construction material is compressed onto the selected deposition surface.

14. The extrusion system of claim 12, wherein the incident angle is between about 30° to about 60° to the print surface.

15. The nozzle of claim 3, wherein the lateral dimension of the outlet is between 25% and 99% of the corresponding lateral dimension of the channel.

16. The nozzle of claim 3, wherein the nozzle further comprises a nozzle tip extension about the nozzle outlet, wherein a longitudinal dimension of the nozzle tip is between 50% and 100% of the lateral dimension of the outlet.

17. The nozzle of claim 4, wherein any of the plurality of serrations traverse between 5% and 25% of the outlet.
